(19) United States
(12) Patent Application Publication
(10) Pub. No.: US 2024/0340116 A1
(43) Pub. Date: Oct. 10, 2024

(54) METHOD, DEVICE AND COMPUTER STORAGE MEDIUM OF COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/575,543

(22) PCT Filed: Jul. 2, 2021
(86) PCT No.: PCT/CN2021/104378

§ 371 Date: Dec. 29, 2023

(51) Int. Cl. H04L 1/1829

(52) U.S. Cl. CPC H04L 1/1854; H04L 1/1861

(57) ABSTRACT

Embodiments of the present disclosure relate to methods, devices and computer readable media for communication. A terminal device receives, from a network device, a plurality of first data transmissions scheduled by first DCI and a second data transmission scheduled by second DCI; and transmits, to the network device, a first HARQ feedback for the plurality of first data transmissions and a second HARQ feedback for the second data transmission, the first HARQ feedback comprising a NACK for a first data transmission in the plurality of first data transmissions that is collided with a configured uplink symbol. In this way, a rule is defined for generation of the HARQ feedback for the multiple data transmissions upon the above collision.

### TECHNICAL FIELD

Embodiments of the present disclosure generally relate to the field of telecommunication, and in particular, to methods, devices and computer storage media of communication during scheduling of multi-transmission time interval (TTI) by downlink control information (DCI) on a single downlink control channel.

### BACKGROUND

Currently, to support new radio (NR) from 52.6 GHz to 71 GHz, it is proposed to employ multi-TTI based scheduling, where one physical downlink control channel (PDCCH) is used to schedule multiple physical uplink shared channels (PUSCHs). In this way, the control signaling overhead can be reduced. Thus, the multi-TTI based scheduling is being also extended to the scheduling of multiple physical downlink shared channels (PDSCHs) by DCI on a single PDCCH.

Currently, it is agreed that sub-codebooks are generated respectively for hybrid automatic repeat request (HARQ) feedbacks for the multiple PDSCHs scheduling by DCI and a single PDSCH scheduled by another DCI. However, more details of the generation of the sub-codebooks are still incomplete.

### SUMMARY

In general, embodiments of the present disclosure provide methods, devices and computer storage media for communication during scheduling of multi-TTI in one downlink control channel.

In a first aspect, there is provided a method of communication. The method comprises: receiving, at a terminal device and from a network device, a plurality of first data transmissions scheduled by first DCI and a second data transmission scheduled by second DCI; and transmitting, to the network device, a first hybrid automatic repeat request (HARQ) feedback for the plurality of first data transmissions and a second HARQ feedback for the second data transmission, the first HARQ feedback comprising a negative acknowledgement (NACK) for a first data transmission in the plurality of first data transmissions that is collided with a configured uplink symbol.

In a second aspect, there is provided a method of communication. The method comprises: receiving, at a terminal device and from a network device, a plurality of data transmissions scheduled by DCI: grouping the plurality of data transmissions based on the number of groups configured for the terminal device; and transmitting, to the network device, a HARQ feedback generated for the grouped data transmissions.

In a third aspect, there is provided a method of communication. The method comprises: receiving, at a terminal device and from a network device, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot; and determining the time domain resource for the corresponding data transmission based on each of the multiple parameters.

In a fourth aspect, there is provided a method of communication. The method comprises: transmitting, at a network device and to a terminal device, a plurality of first data transmissions scheduled by first DCI and a second data transmission scheduled by second DCI; and receiving, from the terminal device, a first HARQ feedback for the plurality of first data transmissions and a second HARQ feedback for the second data transmission, the first HARQ feedback comprising a NACK for a first data transmission in the plurality of first data transmissions that is collided with a configured uplink symbol.

In a fifth aspect, there is provided a method of communication. The method comprises: transmitting, at a network device and to a terminal device, a plurality of data transmissions scheduled by DCI; and receiving, from the terminal device, a HARQ feedback for the plurality of data transmissions grouped based on the number of groups configured for the terminal device.

In a sixth aspect, there is provided a method of communication. The method comprises: transmitting, at a network device and from a terminal device, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot.

In a seventh aspect, there is provided a terminal device. The terminal device comprises a processor and a memory coupled to the processor. The memory stores instructions that when executed by the processor, cause the terminal device to perform the method according to the first aspect of the present disclosure.

In an eighth aspect, there is provided a terminal device. The terminal device comprises a processor and a memory coupled to the processor. The memory stores instructions that when executed by the processor, cause the terminal device to perform the method according to the second aspect of the present disclosure.

In a ninth aspect, there is provided a terminal device. The terminal device comprises a processor and a memory coupled to the processor. The memory stores instructions that when executed by the processor, cause the terminal device to perform the method according to the third aspect of the present disclosure.

In a tenth aspect, there is provided a network device. The network device comprises a processor and a memory coupled to the processor. The memory stores instructions that when executed by the processor, cause the network device to perform the method according to the fourth aspect of the present disclosure.

In an eleventh aspect, there is provided a network device. The network device comprises a processor and a memory coupled to the processor. The memory stores instructions that when executed by the processor, cause the network device to perform the method according to the fifth aspect of the present disclosure.

In a twelfth aspect, there is provided a network device. The network device comprises a processor and a memory coupled to the processor. The memory stores instructions that when executed by the processor, cause the network device to perform the method according to the sixth aspect of the present disclosure.

In a thirteenth aspect, there is provided a computer readable medium having instructions stored thereon. The instructions, when executed on at least one processor, cause the at least one processor to perform the method according to one of the first, second and third aspects of the present disclosure.

In a fourteenth aspect, there is provided a computer readable medium having instructions stored thereon. The instructions, when executed on at least one processor, cause the at least one processor to perform the method according to one of the fourth, fifth and sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram illustrating a process for scheduling one downlink data channel by a single DCI according to embodiments of the present disclosure;

FIG. 2B illustrates a schematic diagram illustrating a process for scheduling multiple data channels by a single DCI according to embodiments of the present disclosure;

FIG. 2C illustrates a schematic diagram illustrating a process for scheduling multiple data channels by a single DCI in multiple serving cells according to embodiments of the present disclosure;

FIG. 3 illustrates a schematic diagram illustrating a process for communication upon that one of multiple downlink data transmissions scheduled by a single DCI is collided with a configured uplink symbol according to embodiments of the present disclosure;

FIG. 4 illustrates a schematic diagram illustrating a process for generating a HARQ feedback for the multiple downlink data transmissions scheduled by a single DCI upon that two of the multiple downlink data transmissions are collided with the configured uplink symbol according to embodiments of the present disclosure;

FIG. 5 illustrates a schematic diagram illustrating an example scenario where only one of the multiple downlink data transmissions is not collided with a configured uplink symbol according to embodiments of the present disclosure;

FIG. 6 illustrates a schematic diagram illustrating an example time domain bundling for a HARQ feedback for multiple downlink data transmissions scheduled by a single DCI according to embodiments of the present disclosure;

FIG. 7 illustrates a schematic diagram illustrating another process for communication upon time domain bundling is applied for multiple data transmissions scheduled by a single DCI according to embodiments of the present disclosure;

FIG. 8 illustrates a schematic diagram illustrating still another process for communication for indication of resources for multiple data transmissions scheduled by a single DCI according to embodiments of the present disclosure;

FIG. 9 illustrates an example method of communication implemented at a terminal device in accordance with some embodiments of the present disclosure;

FIG. 10 illustrates another example method of communication implemented at a terminal device in accordance with some embodiments of the present disclosure;

FIG. 11 illustrates another example method of communication implemented at a terminal device in accordance with some embodiments of the present disclosure;

FIG. 12 illustrates an example method of communication implemented at a network device in accordance with some embodiments of the present disclosure;

FIG. 13 illustrates another example method of communication implemented at a network device in accordance with some embodiments of the present disclosure;

FIG. 14 illustrates another example method of communication implemented at a network device in accordance with some embodiments of the present disclosure; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as “at least one other embodiment.” The terms “first,” ‘second,’ and the like may refer to different or same objects. Other definitions, explicit and implicit, may be included below:

In some examples, values, procedures, or apparatus are referred to as ‘best,’ “lowest,” ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, sub-codebooks are generated respectively for HARQ feedbacks for the multiple PDSCHs scheduling by DCI and a single PDSCH scheduled by another DCI. However, if one or more of the multiple PDSCHs is collided with a configured uplink symbol, it is to be studied how to generate a HARQ feedback for the multiple PDSCHs in this case. Further, if a grouping of the multiple PDSCHs is considered so as to reduce the codebook size of a HARQ feedback for the multiple PDSCHs, it is to be studied how to indicate and apply the number of groups for the grouping. In addition, for time domain resource assignment (TDRA) in DCI that schedules multiple PDSCHs or PUSCHs, if a slot gap between PDSCHs or between PUSCHs is introduced, it is to be studied how to indicate the slot gap.

Embodiments of the present disclosure provide solutions for solving the above and other potential issues. In one aspect, for multiple data transmissions scheduled by DCI and a single data transmission scheduled by another DCI, a first HARQ feedback for the multiple data transmissions and a second HARQ feedback for the single data transmission is generated and transmitted. If one of the multiple data transmissions is collided with a configured uplink symbol, the first HARQ feedback comprises a NACK for the one of the multiple data transmissions. In this way, a rule is defined for generation of the HARQ feedback for the multiple data transmissions upon the above collision.

In another aspect, for multiple data transmissions scheduled by DCI, the multiple data transmissions is grouped based on the number of groups configured for a terminal device, and a HARQ feedback is generated for the grouped data transmissions and then transmitted. In this way, the number of groups for the grouping may be flexibly changed according to the number of scheduled data transmissions.

In still another aspect, for multiple data transmissions scheduled by DCI, multiple parameters for the multiple data transmissions are indicated in the DCI for indicating time domain resources for the multiple data transmissions. Each of the multiple parameters has a single value that indicates a slot gap between a first slot of a corresponding data transmission and a second slot of a previous data transmission and information regarding a starting position and a length of a time domain resource for the corresponding data transmission on the first slot. In this way, it is unnecessary to add a slot gap field or separate slot offset for each start and length indicator (SLIV) in the TDRA.

Principles and implementations of the present disclosure will be described in detail below with reference to the figures.

### Example of Communication Network

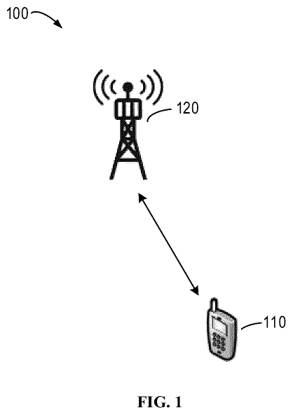

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the terminal device 110 may be served by the network device 120. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the terminal device 110 may transmit uplink data to the network device 120 via an uplink data channel transmission. For example, the uplink data channel transmission may be a PUSCH transmission. Of course, any other suitable forms are also feasible. In some embodiments, the terminal device 110 may receive downlink data from the network device 120 via a downlink data channel transmission. For example, the downlink data channel transmission may be a PDSCH transmission. Of course, any other suitable forms are also feasible.

In some embodiments, the terminal device 110 may receive DCI, e.g., data transmission configuration from the network device 120 via a downlink control channel transmission. For example, the downlink control channel transmission may be a PDCCH transmission. Of course, any other suitable forms are also feasible. In some embodiments, the terminal device 110 may transmit uplink control information (UCI), e.g., HARQ feedback information to the network device 120 via an uplink channel transmission. For example, the uplink channel transmission may be a PUCCH or PUSCH transmission. Of course, any other suitable forms are also feasible.

In some embodiments, the network device 120 may provide a plurality of serving cells (not shown herein) for the terminal device 110, for example, a primary cell (PCell), a primary secondary cell (PSCell), a secondary cell (SCell), a special cell (sPCell) or the like. Each of the serving cells may correspond to a CC. The terminal device 110 may perform transmission with the network device 120 via a CC. Of course, the terminal device 110 may perform transmission with the network device 120 via multiple CCs, for example, in case of CA.

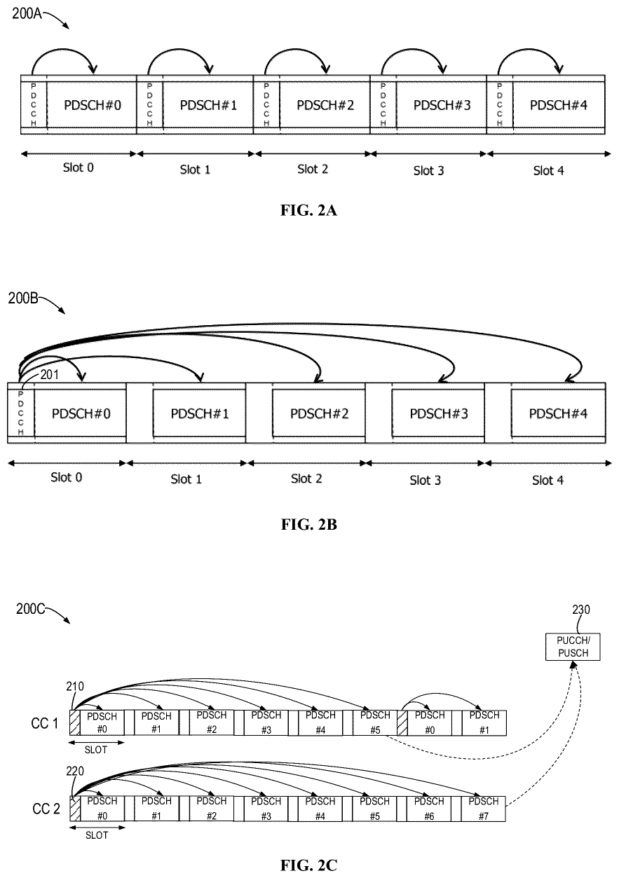

In some embodiments, the network device 120 may schedule one downlink data channel by DCI on a single downlink control channel for the terminal device 110. FIG. 2A illustrates a schematic diagram illustrating a process 200A for scheduling one downlink data channel by a single DCI according to embodiments of the present disclosure. As shown in FIG. 2A, one PDCCH schedules one PDSCH, and each PDSCH occupies a HARQ process number.

In some embodiments, the network device 120 may schedule multiple downlink data channels by DCI on a single downlink control channel for the terminal device 110. FIG. 2B illustrates a schematic diagram illustrating a process 200B for scheduling multiple downlink data channels by a single DCI according to embodiments of the present disclosure. As shown in FIG. 2B, one PDCCH 201 schedules five PDSCHs, i.e., PDSCH #0) to #4.It is to be understood that the number of PDSCHs scheduled in one PDCCH is not limited to the above example, and any other integer larger than one is also feasible. Although FIG. 2B shows one PDCCH scheduling multiple PDSCHs, embodiments of the present disclosure are also applied to one PDCCH scheduling multiple PUSCHs. For convenience, the following description is made by taking one PDCCH scheduling multiple PDSCHs as an example.

In some embodiments, the network device 120 may schedule multiple downlink data channels by a single DCI on multiple serving cells for the terminal device 110. FIG. 2C illustrates a schematic diagram illustrating a process 200C for scheduling multiple downlink data channels by DCI in multiple serving cells according to embodiments of the present disclosure. As shown in FIG. 2C, there are two serving cells CC1 and CC2. At a monitoring occasion in CC1, one PDCCH 210 schedules six PDSCHs, i.e., PDSCH #0) to #5, and indicates that a HARQ feedback for the six PDSCHs is transmitted on PUCCH/PUSCH 230. At the same monitoring occasion in CC2, one PDCCH 220 schedules eight PDSCHs, i.e., PDSCH #0) to #7, and indicates that a HARQ feedback for the eight PDSCHs is also transmitted on PUCCH/PUSCH 230.

It is to be understood that the number of PDSCHs scheduled in one PDCCH is not limited to the above example, and any other integer larger than one and smaller than nine is also feasible.

In some embodiments, Type-2 HARQ-acknowledgement (HARQ-ACK) codebook may be generated for a HARQ feedback for one or multiple data transmissions scheduled by a single DCI. In some embodiments where a counter-downlink assignment index (c-DAI) or total-DAI (t-DAI) is counted per DCI during generation of the Type-2 HARQ-ACK codebook, a sub-codebook (also referred to as a first codebook for convenience) may be generated for the multiple data transmission scheduled by a single DCI, and another sub-codebook (also referred to as a second codebook for convenience) may be generated for the one data transmission scheduled by another single DCI.

### Example Implementation of HARQ Feedback for Data Transmissions Scheduled in DCI

In some scenarios, one or more of multiple PDSCHs scheduled by a single DCI may be collided with one or more configured uplink symbols, for example, indicated by a time division duplexing (TDD) configuration. In this case, how to place HARQ-ACK bits in the first codebook is unclear.

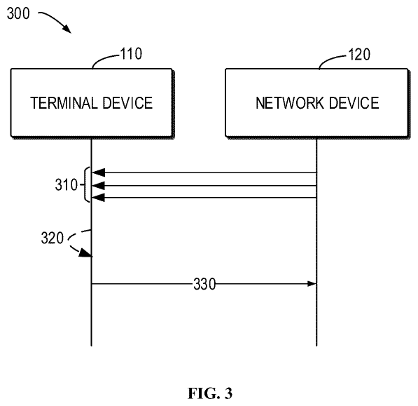

In view of this, embodiments of the present disclosure provide a solution for generating a HARQ feedback for one or multiple data channels by a single DCI. This will be described in detail with reference to FIGS. 3 to 5. FIG. 3 illustrates a schematic diagram illustrating a process 300 for communication upon that one of multiple downlink data transmissions scheduled by a single DCI is collided with a configured uplink symbol according to embodiments of the present disclosure. For the purpose of discussion, the process 300 will be described with reference to FIG. 1. The process 300 may involve the terminal device 110 and the network device 120 as illustrated in FIG. 1.

As shown in FIG. 3, the network device 120 may transmit 310 one or multiple data transmissions to the terminal device 110. In some embodiments, the network device 120 may transmit, to the terminal device 110, a plurality of data transmissions (also referred to as first data transmissions herein for convenience) scheduled by a single DCI (also referred to as first DCI herein for convenience). In some embodiments, the network device 120 may transmit, to the terminal device 110, a data transmission (also referred to as a second data transmission herein for convenience) scheduled by a single DCI (also referred to as second DCI herein for convenience).

Upon receipt of the one or multiple data transmissions, the terminal device 110) may generate 320 a HARQ feedback for the one or multiple data transmissions. In some embodiments where the plurality of first data transmissions and the second data transmission are received by the terminal device 110, the terminal device 110 may generate a first HARQ feedback for the plurality of first data transmissions and a second HARQ feedback for the second data transmission. If a first data transmission in the plurality of first data transmissions is collided with the configured uplink symbol(s) (that is, the first data transmission is unavailable), the terminal device 110 may generate the first HARQ feedback comprising a NACK for the first data transmission. In other words, if at least one data transmission in the plurality of first data transmissions is collided with the configured uplink symbol(s), the terminal device 110 may generate the first HARQ feedback comprising at least one NACK for the at least one collided data transmission. An example placement of the NACK in the first HARQ feedback will be described in connection with Embodiments 1 and 2.

### Embodiment 1

In this embodiment, the terminal device 110 may generate a first codebook for the first HARQ feedback, the first codebook comprising the NACK in a HARQ-ACK bit position corresponding to a scheduled position for the collided first data transmission. In other words, the first codebook may comprise at least one NACK in at least one HARQ-ACK bit position corresponding to at least one scheduled position for the at least one collided data transmission.

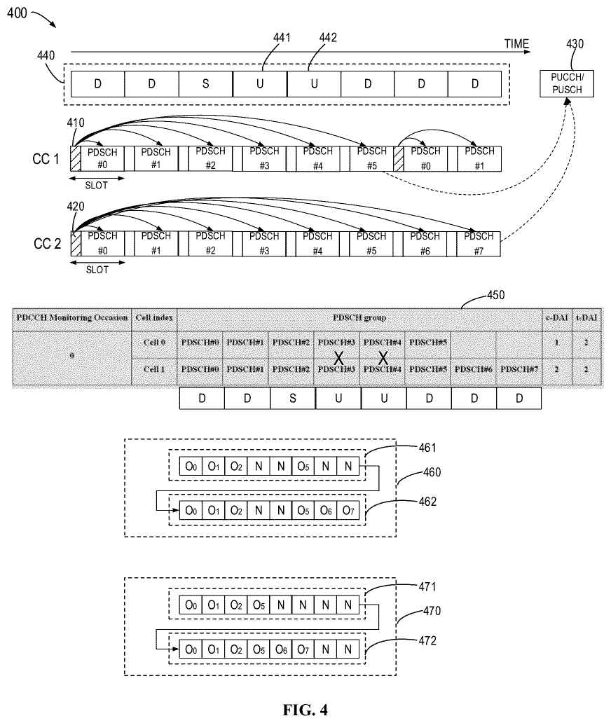

For example, when generating Type-2 HARQ-ACK codebook corresponding to a DCI that can schedule multiple PDSCHs, the terminal device 110 may need to report a fixed number of HARQ-ACK bits for each DCI with scheduling multiple PDSCHs in the first codebook. If there is a collision between any of scheduled PDSCHs of a single DCI and one or more uplink symbols indicated by TDD configuration, when generating the fixed number of HARQ-ACK payload, the terminal device 110 may not change its position in TDRA table and only pad NACK for the invalid conflictive slot. For clarity, an example will be described in details with reference to FIG. 4.

FIG. 4 illustrates a schematic diagram illustrating a process 400 for generating a HARQ feedback for the multiple downlink data transmissions scheduled by a single DCI upon that two of the multiple downlink data transmissions are collided with the configured uplink symbol according to embodiments of the present disclosure.

As shown in FIG. 4, there are two serving cells CC1 and CC2 (also denoted as Cell 0 and Cell 1 herein). At PDCCH monitoring occasion #0, PDCCH 410 in CC 1 schedules six PDSCHs, i.e., PDSCH #0) to #5, and indicates that a HARQ feedback for the six PDSCHs is transmitted on PUCCH/PUSCH 430. At the same monitoring occasion, PDCCH 420 in CC 2 schedules eight PDSCHs, i.e., PDSCH #0 to #7, and indicates that a HARQ feedback for the eight PDSCHs is also transmitted on PUCCH/PUSCH 430.

It can be seen from FIG. 4 that PDSCH #3 and PDSCH #4 in CC1 and CC2 are collided with uplink symbols 441 and 442 indicated in a TDD configuration 440 for the terminal device 110. A HARQ codebook may be concluded based on a table denoted by 450. In this example, CC 1 is configured with a TDRA table where the maximum number of SLIVs in all of rows is equal to 6, while CC 2 is configured with TDRA table where the maximum number of SLIVs in all of rows is equal to 8. In this case, the fixed number of HARQ-ACK bits across all serving cells corresponding to a DAI is max (6,8).

In some embodiments, the terminal device 110 will pad NACK for the invalid conflictive slots. That is, the terminal device 110 may pad HARQ-ACK bit positions corresponding to the scheduled positions of PDSCH #3 and PDSCH #4 with NACK. In addition, to avoid codebook size misalignment, the terminal device 110 may pad the last two HARQ-ACK bits positions for CC 1 with NACKs. Thus, the terminal device 110 may generate a HARQ codebook 460 comprising HARQ-ACK bits 461 for CC1 and HARQ-ACK bits 462 for CC2.

### Embodiment 2

In this embodiment, the terminal device 110 may generate a first codebook for the first HARQ feedback, the first codebook comprising the NACK behind HARQ-ACK bits for actual data transmissions in the plurality of first data transmissions other than the collided first data transmission (i.e., one or more collided data transmissions). In other words, when generating the fixed number of HARQ-ACK payload, the terminal device 110 may pad NACK for the invalid conflictive slot, and actual PDSCHs scheduled by a single DCI is counted firstly, and then the invalid (omitted) slots follow behind.

Still with reference to the example in FIG. 4, the fixed number of HARQ-ACK bits across all serving cells corresponding to a DAI is max (6,8). Then the terminal device 110 may pad NACK for the invalid conflictive slots, and place them behind the valid slots. Thus, the terminal device 110 may generate a HARQ codebook 470 comprising HARQ-ACK bits 471 for CC1 and HARQ-ACK bits 472 for CC2.

In this way, a rule for placement of a NACK for the collided data transmission may be defined.

In some scenarios, only one of the multiple data transmissions scheduled by a single DCI is not collided with a configured uplink symbol, that is, other data transmissions in the multiple data transmissions are collided with configured uplink symbols. The generation of a HARQ feedback in this case will be described in details in connection with Embodiments 3 and 4.

### Embodiment 3

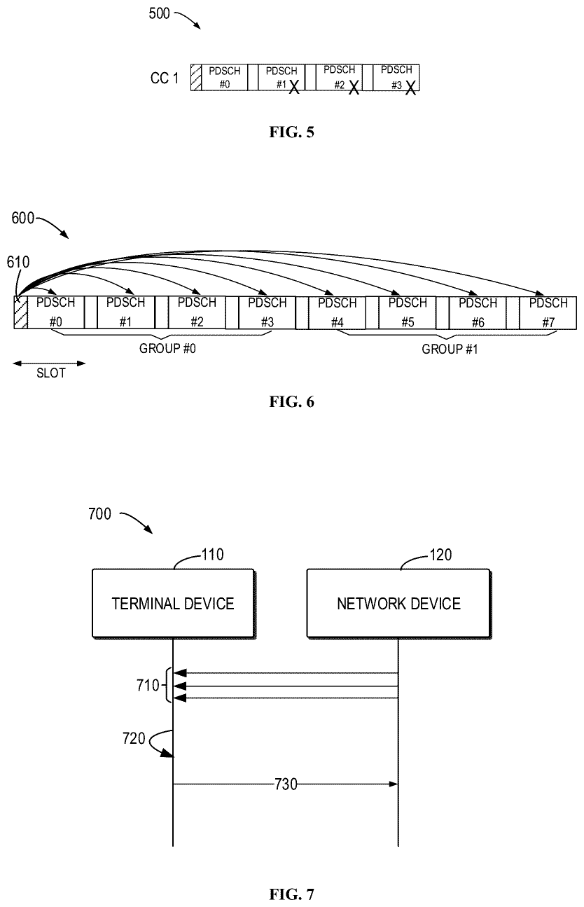

FIG. 5 illustrates a schematic diagram illustrating an example scenario 500 where only one of the multiple downlink data transmissions is not collided with a configured uplink symbol according to embodiments of the present disclosure.

For example, assuming that the TDRA table is shown in Table 1.

TABLE 1
An Example TDRA Table

| | |
|---|---|
| Index = 0 | {SLIV R0_0} |
| Index = 1 | {SLIV R1_0, SLIV R1_1} |
| Index = 2 | {SLIV R2_0, SLIV R2_1, SLIV R2_2, SLIV R2_3} |

For example, the terminal device 110 is scheduled with index 1 or 2. However, a PDSCH or several PDSCHs among multiple PDSCHs that are scheduled by a single DCI is collided with uplink symbol(s) indicated by tdd-UL-DL-ConfigurationCommon or tdd-UL-DL-ConfigurationDedicated, and actually only one PDSCH is scheduled in this DCI. As shown in FIG. 5, PDSCH #1 to #3 in CC 1 are collided with configured uplink symbols. In this case, only one PDSCH #0 is actually scheduled in the corresponding DCI.

In this embodiment, the one PDSCH #0 may still belong to the first codebook for multiple PDSCHs scheduled in a single DCI. In this case, the terminal device 110 may generate the first codebook for multiple PDSCHs scheduled in the first DCI and the second codebook for a single PDSCH scheduled in the second DCI, the first HARQ feedback comprising HARQ feedback for the PDSCH #0 and NACKs for other data transmissions PDSCH #1 to #3.

It is to be understood that the example of FIG. 4 is merely for illustration, and does not make limitation for the present disclosure. Any other suitable ways are also feasible.

### Embodiment 4

As an alternative for Embodiment 3, if only one of the plurality of first data transmissions (for example, PDSCH #0 in FIG. 5) is not collided with a configured uplink symbol, the one PDSCH #0 may be changed to belong to the second codebook for a single PDSCH scheduled in a single DCI. In this case, for the multiple PDSCHs scheduled in the first DCI, the terminal device 110 may generate the first HARQ feedback comprising only a HARQ feedback for PDSCH #0. For the single PDSCH scheduled in the second DCI, the terminal device 110 may generate the second HARQ feedback for the single PDSCH. Then, the terminal device 110 may generate a codebook with a set of c-DAI and t-DAI for the first and second HARQ feedbacks. In this way, the codebook size may be reduced and corresponding overhead may be saved.

In some scenarios, time domain bundling may be supported during generation of the first HARQ feedback for multiple PDSCHs scheduled by a single DCI. The size of the first codebook may be reduced by introducing grouping among the multiple PDSCHs. In some cases, the first codebook and the second codebook may be combined into one codebook. The generation of the first and second HARQ feedbacks in these cases will be described in details in connection with Embodiments 5 and 6.

### Embodiment 5

In this embodiment, the terminal device 110 may generate the first HARQ feedback by grouping the plurality of first data transmissions (for example, PDSCHs) into a plurality of groups, and generate the second HARQ feedback by padding HARQ-ACK bits with a NACK so that the number of HARQ-ACK bits for the second HARQ feedback is equal to that for the first HARQ feedback. Then, the terminal device 110 may generate a codebook for the first and second feedbacks.

For example, the number of groups (also referred to as grouping number herein) may be 2. For illustration, an example will be described with reference to FIG. 6. FIG. 6 illustrates a schematic diagram illustrating an example time domain bundling 600 for a HARQ feedback for multiple downlink data transmissions scheduled by a single DCI according to embodiments of the present disclosure. As shown in FIG. 6, PDCCH 610 schedules eight PDSCHs, i.e., PDSCH #0 to #7. PDSCH #0 to #3 occupy Group #0, and PDSCH #4 to #7 occupy Group #1. In this case, the terminal device 110 may generate the first feedback having two HARQ-ACK bits.

Assuming that ITB is supported by serving cells of the terminal device 110. In this case, the terminal device 110 may generate the second feedback having two HARQ-ACK bits with a NACK padded in one of the two HARQ-ACK bits. In this way, the terminal device 110 may generate one codebook with a set of c-DAI and t-DAI for the first and second feedbacks.

It is to be understood that any other suitable number is also feasible as the grouping number, and the present disclosure does not limit this aspect.

### Embodiment 6

In this embodiment, the terminal device 110 may generate the first HARQ feedback by grouping the plurality of first data transmissions (for example, PDSCHs) into a plurality of groups. The maximum number of transport blocks (TBs) supported by serving cells of the terminal device 110 is equal to the number of the plurality of groups. Then the terminal device 110 may generate the second HARQ feedback having the same number of HARQ-ACK bits as that for the first HARQ feedback. Then, the terminal device 110 may generate a codebook with a set of c-DAI and t-DAI for the first and second feedbacks.

For example, the number of groups may be 2. If any of the serving cells of the terminal device 110 supports 2TBs, the terminal device 110 may generate the codebook with a set of c-DAI and t-DAI for the first and second feedbacks. It is to be understood that any other suitable number is also feasible as the grouping number, and the present disclosure does not limit this aspect.

Returning to FIG. 3, upon generation of the HARQ feedback for the one or multiple data transmissions, the terminal device 110 transmits the HARQ feedback to the network device 120. In this way, the HARQ feedback details in some special cases are clarified and a tradeoff for UCI payload and HARQ feedback efficiency is found.

### Example Implementation of HARQ Feedback for Grouped Data Transmissions

In some scenarios, if c-DAI or t-DAI is counted per DCI when generating Type-2 HARQ-ACK codebook, the assumption is to reuse the c-DAI or t-DAI design in Rel-16. To resolve the codebook size misalignment issue, the terminal device 110 may report a fixed number of HARQ-ACK bits for each DCI with scheduling multiple PDSCHs in the first codebook. It will bring redundancy in the codebook when the fixed number is larger than the scheduled PDSCHs. So it is expected that the codebook size can be reduced by introducing PDSCH grouping among the multiple scheduled PDSCHs. However, how to indicate and apply the grouping number need to be discussed.

Embodiments of the present disclosure provide a solution for enhancing HARQ feedback for multiple downlink data channels scheduled by DCI on a single downlink control channel. According to embodiments of the present disclosure, the multiple PDSCHs are grouped based on the configured number of groups and a HARQ feedback is generated for the grouped PDSCHs. This will be described in detail with reference to FIG. 7.

FIG. 7 illustrates a schematic diagram illustrating another process 700 for communication upon time domain bundling is applied for multiple data transmissions scheduled by a single DCI according to embodiments of the present disclosure. For the purpose of discussion, the process 700 will be described with reference to FIG. 1. The process 700 may involve the terminal device 110 and the network device 120 as illustrated in FIG. 1.

As shown in FIG. 7, the network device 120 transmits 710, to the terminal device 110, a plurality of data transmissions scheduled by a single DCI. Upon receipt of the plurality of data transmissions, the terminal device 110 groups 720 the plurality of data transmissions based on the number of groups configured for the terminal device 110. Some examples of the grouping will be described below in connection with Embodiments 7 to 9.

### Embodiment 7

In this embodiment, the number of groups may be commonly configured for serving cells of the terminal device 110. In this case, the network device 120 may configure a common grouping number for the terminal device 110, and the terminal device 110 may apply the common grouping number across all the serving cells scheduling multiple PDSCHs if the common grouping number is available.

In some embodiments, the network device 120 may configure the number of groups to the terminal device 110 via a RRC message. For example, a set of group size may be configured as below:

| | |
|---|---|
| PUCCH-Config ::= | SEQUENCE { |

...

| | | |
|---|---|---|
| pdsch-GroupNumber | ENUMERATED {n2, n3, n4} | OPTIONAL, |

...
}

It is to be understood that the number of groups may be configured via any other suitable ways, and the present disclosure does not limit this aspect.

### Embodiment 8

In this embodiment, the number of groups may be differently configured for each of serving cells of the terminal device 110. In this case, the network device 120 may configure a separate grouping number for each serving cell of the terminal device 110, and the grouping number will be updated upon addition of a new cell with a capability of scheduling multiple PDSCHs.

In some embodiments, the terminal device 110 may determine the maximum number among the numbers of groups configured for serving cells establishing a connection with the terminal device 110, and group the plurality of data transmissions based on the maximum number. In other words, the terminal device 110 may always use the maximum configured grouping number among all the serving cells that establish a connection with the terminal device 110. In this way, the network device 120 may change the grouping number flexibly according to a TDRA table.

For example, serving cell #1 is configured with a grouping number equal to 2, and serving cell #2 is configured with another grouping number equal to 3. In this case, a grouping number across serving cells #1 and #2 corresponding to a DAI may be max (2,3). Subsequently, serving cell #3 is added, that is, the terminal device 110 establishes a connection with serving cell #3. As serving cell #3 is configured with a new grouping number equal to 4, a grouping number across serving cell #1, #2 and #3 corresponding to a DAI may be max (2,3,4).

In some embodiments, the network device 120 may configure the number of groups to the terminal device 110 via a RRC message. For example, a set of group size may be configured as below:

| | |
|---|---|
| PDSCH -Config ::= | SEQUENCE { |

...

| | | |
|---|---|---|
| pdsch-GroupNumber | ENUMERATED {n2, n3, n4} | OPTIONAL, |

...
}

It is to be understood that the number of groups may be configured via any other suitable ways, and the present disclosure does not limit this aspect.

### Embodiment 9

In this embodiment, the number of groups may be configured (for example, via a RRC message) for each of serving cells of the terminal device 110, and the terminal device 110 does not apply the number of groups to perform the grouping of the plurality of data transmissions until an indication to enable the grouping is received.

In some embodiments, the network device 120 may transmit an indication on whether the grouping is enabled to the terminal device 110. Based on the indication, the terminal device 110 may determine whether the number of groups is applied for the grouping. In some embodiments, the network device 120 may transmit the indication via a medium access control (MAC) control element (CE). Of course, any other suitable ways are also feasible to transmit the indication, and the present disclosure does not limit this aspect.

In some embodiments, the network device 120 may transmit, as the indication, a first indication for enabling the grouping. In this case, the terminal device 110 may group the plurality of data transmissions in response to receiving the first indication. In some embodiments, the terminal device 110 may apply the configured number of groups across all the serving cells with scheduling multiple PDSCHs if the configured number of groups is available. In some embodiments, the terminal device 110 may adopt the enabling of the grouping after a time point A, e.g. slot n+N, where n denotes an index of a slot in which ACK for the first indication is transmitted to the network device 120, and N denotes a fixed processing delay for processing of the ACK at the network device 120.

In some embodiments, the network device 120 may transmit, as the indication, a second indication for disabling the grouping. For example, if the network device 120 wants to stop PDSCH grouping for HARQ codebook of multi-PDSCH scheduling, the network device 120 may transmit the second indication to the terminal device 110. In response to receiving the second indication, the terminal device 110 may generate a HARQ feedback for the plurality of data transmissions without grouping the plurality of data transmissions.

In this way, the network device 120 may adjust the codebook size according to the uplink channel fluctuation without adding any addition bit in DCI.

Returning to FIG. 7, upon grouping of the plurality of data transmissions, the terminal device 110 generates and transmits 730 a HARQ feedback for the grouped data transmissions. In this way, a HARQ feedback overhead may be reduced.

### Example Implementation of Indication of Slot Gap Between Data Transmissions

For operation in 480 KHz or 960 KHz sub-carrier spacing (SCS), the maximum number of scheduled data transmissions (such as PDSCHs or PUSCHs) can be up to 8. A row of a TDRA table in DCI may indicate scheduled data transmissions that are in consecutive or non-consecutive slots. How to indicate the non-consecutive slots in the TDRA table is unclear.

Table 1 below shows an example TDRA table in a DCI that schedules a single data transmission.

TABLE 1
An Example TDRA Table for Single Data
Transmission Scheduled in DCI

| Row Index | K0 | SLIV |
|---|---|---|
| 0 | 8 | 40 |
| 1 | 12 | 40 |
| 2 | 16 | 40 |

Parameter K0 in Table 1 indicates an offset between a scheduling slot corresponding to the scheduling PDCCH and a scheduled slot corresponding to the scheduled data transmission. Parameter SLIV in Table 1 indicates a starting position and a length of a time domain resource for the scheduled data transmission in the scheduled slot.

For a TDRA table in a DCI that schedules multiple data transmissions, it is expected to introduce a slot gap between data transmissions. Table 2 shows an example TDRA table in a DCI that schedules multiple data transmissions according to a conventional solution.

TABLE 2
An Example TDRA Table According to Conventional Solution

| Row | | | | | | | | | |
|---|---|---|---|---|---|---|---|---|---|
| Index | K0 | SLIV1 | SLIV2 | SLIV3 | SLIV4 | SLIV5 | SLIV6 | SLIV7 | SLIV8 |
| 0 | 8 | 0, 40 | 1, 54 | | | | | | |
| 1 | 12 | 0, 40 | 1, 54 | 0, 96 | 1, 68 | | | | |
| 2 | 16 | 0, 40 | 1, 54 | 0, 96 | 1, 68 | 0, 64 | 2, 100 | 0, 96 | 0, 67 |

Row index in Table 2 is associated with the number of the scheduled data transmissions. For example, row index 0 indicates resources for the scheduled data transmissions in case that the number of the scheduled data transmissions is 2. Row index 1 indicates resources for the scheduled data transmissions in case that the number of the scheduled data transmissions is 4. Row index 2 indicates resources for the scheduled data transmissions in case that the number of the scheduled data transmissions is 8.

For each row index of the TDRA table, there is a common parameter K0. Parameter K0 in Table 2 indicates an offset between a slot of the scheduling PDCCH and a slot of the first scheduled PDSCH. Each of parameters SLIV1 to SLIV8 in Table 2 comprises two fields (for example, (0, 40) in row index 0), one indicating a slot gap between a scheduled slot of the corresponding data transmission and a scheduled slot of previous data transmission and the other indicating a starting position and a length of a time domain resource for the corresponding data transmission.

Embodiments of the present disclosure provide an improved solution for indicating resources of data transmissions scheduled in DCI. Instead of using two fields for each parameter SLIV1 to SLIV8 in Table 2, a single field is used in the present solution to indicate both a slot gap between a first slot of a corresponding data transmission and a second slot of a previous data transmission and information regarding a starting position and a length of a time domain resource for the corresponding data transmission on the first slot. Table 3 shows an example TDRA table in a DCI that schedules multiple data transmissions according to embodiments of the present disclosure.

TABLE 3
An Example TDRA Table According to The Present Solution

| Row | | | | | | | | | |
|---|---|---|---|---|---|---|---|---|---|
| Index | K0 | SLIV1 | SLIV2 | SLIV3 | SLIV4 | SLIV5 | SLIV6 | SLIV7 | SLIV8 |
| 0 | 8 | 40 | 182 | | | | | | |
| 1 | 12 | 40 | 182 | 96 | 196 | | | | |
| 2 | 16 | 40 | 182 | 96 | 196 | 64 | 356 | 96 | 67 |

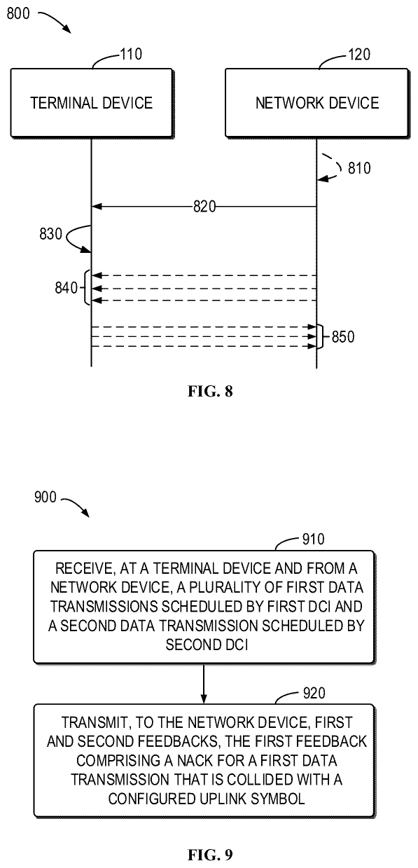

Parameter K0 in Table 3 indicates a slot offset between the scheduling PDCCH and the first scheduled PDSCH. Each of parameters SLIV1 to SLIV8 in Table 2 comprises a single field having a single value ((for convenience, denoted as SLIV1 hereinafter). The single value indicates the slot gap between a scheduled slot of the corresponding data transmission and a scheduled slot of previous data transmission and information regarding a starting position and a length of a time domain resource for the corresponding data transmission. In other words, the slot gap between the scheduled slots of the corresponding data transmission and previous data transmission and the information regarding the starting position and the length may be determined from the single value. This will be described in detail with reference to FIG. 8.

FIG. 8 illustrates a schematic diagram illustrating still another process 800 for communication for indication of resources for multiple data transmissions scheduled by a single DCI according to embodiments of the present disclosure. For the purpose of discussion, the process 800 will be described with reference to FIG. 1. The process 800 may involve the terminal device 110 and the network device 120 as illustrated in FIG. 1.

As shown in FIG. 8, the network device 120 may generate 810 DCI scheduling multiple data transmissions. The DCI indicates multiple parameters (for example, SLIV1 to SLIV8 in Table 3) for the multiple data transmissions, and each of the multiple parameters having a single value (SLIV1) that indicates a slot gap (denoted as SLIV2 hereafter) between a first slot of a corresponding data transmission and a second slot of a previous data transmission and information (denoted as SLIV3 hereafter) regarding a starting position and a length of a time domain resource for the corresponding data transmission on the first slot.

The network device 120 transmits 820 the DCI indicating the multiple parameters to the terminal device 110. Based on each of the multiple parameters, the terminal device 110 determines 830 the time domain resource for the corresponding data transmission. In some embodiments, the terminal device 110 may determine the slot gap SLIV₂ by equation (1) below:

$${SLIV}_{2} = ⌊ {SLIV}_{1} / 128 ⌋ \qquad ( 1 )$$

where SLIV2 denotes a slot gap between a first slot of a corresponding data transmission and a second slot of a previous data transmission, and SLIV1 denotes a single value of the parameter for the corresponding data transmission in DCI.

In some embodiments, the terminal device 110 may determine the information SLIV₃ by equation (2) below:

$${SLIV}_{3} = mod ( {SLIV}_{1} , 128 ) \qquad ( 2 )$$

where SLIV3 denotes information regarding a starting position and a length of a time domain resource for the corresponding data transmission on the first slot, and SLIV1 denotes a single value of the parameter for the corresponding data transmission in DCI.

It is to be understood that the above Table 3 is merely an example, and does not make limitation for the present disclosure. Further, the above equations are merely examples, any other suitable forms for the equations are also feasible.

Returning to FIG. 8, in some embodiments where the multiple data transmissions are PDSCHs, the terminal device 110 may receive 840 the multiple data transmissions on the determined time domain resources. In some embodiments where the multiple data transmissions are PUSCHs, the terminal device 110 may transmit 850 the multiple data transmissions on the determined time domain resources.

In this way, it is unnecessary to add a slot gap field or separate slot offset for each SLIV in the TDRA table.

### Example Implementation of Methods

Accordingly, embodiments of the present disclosure provide methods of communication implemented at a terminal device and a network device. These methods will be described below with reference to FIGS. 9 to 14.

FIG. 9 illustrates an example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 receives, from the network device 120, a plurality of first data transmissions scheduled by first DCI and a second data transmission scheduled by second DCI.

At block 920, the terminal device 110 transmits, to the network device 120, a first HARQ feedback for the plurality of first data transmissions and a second HARQ feedback for the second data transmission, the first HARQ feedback comprising a NACK for a first data transmission in the plurality of first data transmissions that is collided with a configured uplink symbol.

In some embodiments, the terminal device 110 may transmit a first codebook for the first HARQ feedback, the first codebook comprising the NACK in a HARQ-ACK bit position corresponding to a scheduled position for the collided first data transmission. In some embodiments, the terminal device 110 may transmit a first codebook for the first HARQ feedback, the first codebook comprising the NACK behind HARQ-ACK bits for data transmissions in the plurality of first data transmissions other than the collided first data transmission.

In some embodiments, if only one of the plurality of first data transmissions is not collided with a configured uplink symbol, the terminal device 110 may generate a codebook for the first and second HARQ feedbacks, the first HARQ feedback being only for the one of the plurality of first data transmissions, and transmit the codebook to the network device 120.

In some embodiments, if only one of the plurality of first data transmissions is not collided with a configured uplink symbol, the terminal device 110 may generate a first codebook for the first HARQ feedback and a second codebook for the second HARQ feedback, the first HARQ feedback comprising HARQ feedback for the one of the plurality of first data transmissions and NACKs for other data transmissions in the plurality of first data transmissions, and transmit the codebook to the network device 120.

In some embodiments, the terminal device 110 may generate the first HARQ feedback by grouping the plurality of first data transmissions into a plurality of groups; generate the second HARQ feedback by padding HARQ-ACK bits with a NACK so that the number of HARQ-ACK bits for the second HARQ feedback is equal to that for the first HARQ feedback: generate a codebook for the first and second feedbacks; and transmit the codebook to the network device 120.

In some embodiments, the terminal device 110 may generate the first HARQ feedback by grouping the plurality of first data transmissions into a plurality of groups; generate the second HARQ feedback, wherein the maximum number of transport blocks supported by serving cells of the terminal device is equal to the number of the plurality of groups: generate a codebook for the first and second feedbacks; and transmit the codebook to the network device 120.

In this way, a rule is defined for generation of the HARQ feedback for the multiple data transmissions upon the above collision.

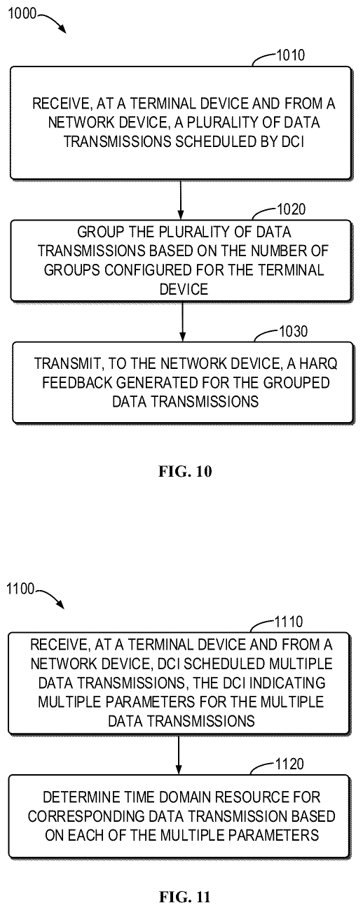

FIG. 10 illustrates another example method 1000 of communication implemented at a terminal device in accordance with some embodiments of the present disclosure. For example, the method 1000 may be performed at the terminal device 110 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the terminal device 110 receives, from the network device 120, a plurality of data transmissions scheduled by DCI.

At block 1020, the terminal device 110 groups the plurality of data transmissions based on the number of groups configured for the terminal device 110. In some embodiments, the number of groups is commonly configured for serving cells of the terminal device 110.

In some embodiments, the number of groups is differently configured for each of serving cells of the terminal device 110. In these embodiments, the terminal device 110 may group the plurality of data transmissions by determining the maximum number among the numbers of groups configured for serving cells establishing a connection with the terminal device; and grouping the plurality of data transmissions based on the maximum number.

In some embodiments, the terminal device 110 may group the plurality of data transmissions by receiving, from the network device 120, a first indication for enabling the grouping; and grouping the plurality of data transmissions in response to the first indication.

At block 1030, the terminal device 110 transmits, to the network device 120, a HARQ feedback generated for the grouped data transmissions. In some embodiments, the terminal device 110 may receive, from the network device 120, a second indication for disabling the grouping, and transmit, to the network device 120, a further HARQ feedback generated for the plurality of data transmissions without grouping the plurality of data transmissions.

In this way, the number of groups for the grouping may be flexibly changed according to the number of scheduled data transmissions.

FIG. 11 illustrates another example method 1100 of communication implemented at a terminal device in accordance with some embodiments of the present disclosure. For example, the method 1100 may be performed at the terminal device 110 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

As shown in FIG. 11, at block 1110, the terminal device 110 receives, from the network device 120, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot. That is, the single value indicates both the slot gap and the information.

At block 1120, the terminal device 110 determines the time domain resource for the corresponding data transmission based on each of the multiple parameters. In some embodiments, the terminal device 110 may determine the slot gap between the first and second slots by [SLIV₁/128]; and determine the information regarding the starting position and the length of the time domain resource on the first slot by mod (SLIV₁, 128), where SLIV₁ denotes the single value of each of the multiple parameters.

In this way, it is unnecessary to add a slot gap field or separate slot offset for each SLIV in the TDRA table.

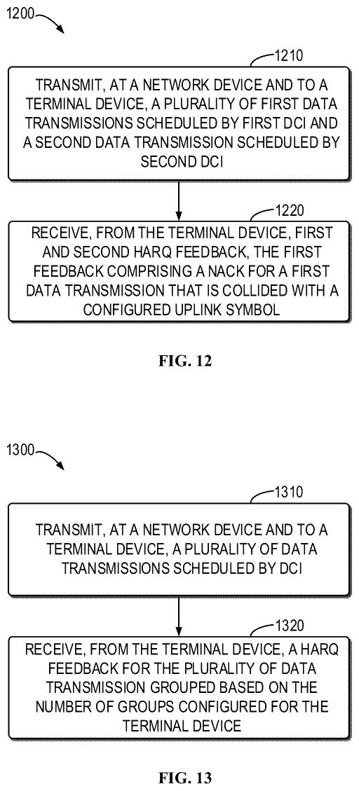

FIG. 12 illustrates an example method 1200 of communication implemented at a network device in accordance with some embodiments of the present disclosure. For example, the method 1200 may be performed at the network device 120 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

As shown in FIG. 12, at block 1210, the network device 120 transmits, to the terminal device 110, a plurality of first data transmissions scheduled by first DCI and a second data transmission scheduled by second DCI.

At block 1220, the network device 120 receives, from the terminal device 110, a first HARQ feedback for the plurality of first data transmissions and a second HARQ feedback for the second data transmission, the first HARQ feedback comprising a NACK for a first data transmission in the plurality of first data transmissions that is collided with a configured uplink symbol.

In some embodiments, the network device 120 may receive a first codebook for the first HARQ feedback, the first codebook comprising the negative acknowledgement in a HARQ-ACK bit position corresponding to a scheduled position for the collided first data transmission.

In some embodiments, the network device 120 may receive a first codebook for the first HARQ feedback, the first codebook comprising the negative acknowledgement behind HARQ-ACK bits for data transmissions in the plurality of first data transmissions other than the collided first data transmission.

In some embodiments, the network device 120 may receive a codebook for the first and second HARQ feedbacks, the first HARQ feedback being only for one of the plurality of first data transmissions, only the one of the plurality of first data transmissions being not collided with a configured uplink symbol.

In some embodiments, the network device 120 may receive a first codebook for the first HARQ feedback and a second codebook for the second HARQ feedback, the first HARQ feedback comprising a NACK or ACK for one of the plurality of first data transmissions and NACKs for other data transmissions in the plurality of first data transmissions, only the one of the plurality of first data transmissions is not collided with a configured uplink symbol.

In some embodiments, the network device 120 may receive a codebook for the first and second feedbacks, the first feedback being generated by grouping the plurality of first data transmissions into a plurality of groups, the second HARQ feedback being generated by padding HARQ-ACK bits for the second HARQ feedback with a NACK so that the number of HARQ-ACK bits for the second HARQ feedback is equal to that for the first HARQ feedback.

In some embodiments, the network device 120 may receive a codebook for the first and second feedbacks, the first HARQ feedback being generated by grouping the plurality of first data transmissions into a plurality of groups, the maximum number of transport blocks supported by serving cells of the terminal device being equal to the number of the plurality of groups.

In this way, rule is defined for generation of the HARQ feedback for the multiple data transmissions upon the above collision.

FIG. 13 illustrates another example method 1300 of communication implemented at a network device in accordance with some embodiments of the present disclosure. For example, the method 1300 may be performed at the network device 120 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

As shown in FIG. 13, at block 1310, the network device 120 transmits, to the terminal device 110, a plurality of data transmissions scheduled by DCI.

At block 1320, the network device 120 receives, from the terminal device 110, a HARQ feedback for the plurality of data transmissions grouped based on the number of groups configured for the terminal device 110. In some embodiments, the number of groups may be commonly configured for serving cells of the terminal device 110.

In some embodiments, the number of groups may be differently configured for each of serving cells of the terminal device. In these embodiments, the plurality of data transmissions is grouped based on the maximum number among the numbers of groups configured for serving cells establishing a connection with the terminal device 110.

In some embodiments, the network device 120 may transmit, to the terminal device 110, a first indication for enabling the grouping. In some embodiments, the network device 120 may transmit, to the terminal device 110, a second indication for disabling the grouping; and receive, from the terminal device 110, a further HARQ feedback generated for the plurality of data transmissions.

In this way, the number of groups for the grouping may be flexibly changed according to the number of scheduled data transmissions.

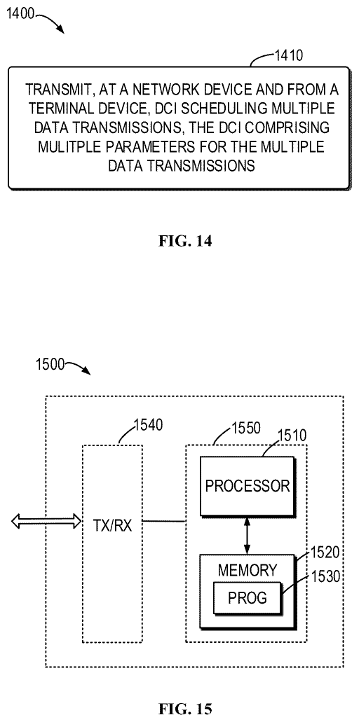

FIG. 14 illustrates another example method 1400 of communication implemented at a network device in accordance with some embodiments of the present disclosure. For example, the method 1400 may be performed at the network device 120 as shown in FIG. 1. For the purpose of discussion, in the following, the method 1400 will be described with reference to FIG. 1. It is to be understood that the method 1400 may include additional blocks not shown and/or may omit some blocks as shown, and the scope of the present disclosure is not limited in this regard.

As shown in FIG. 14, at block 1410, the network device 120 transmits, to the terminal device 110, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot.

In some embodiments, the slot gap between the first and second slots may be determined by [SLIV₁/128], where SLIV₁ denotes the single value of each of the multiple parameters. The information regarding the starting position and the length of the time domain resource on the first slot may be determined by mod (SLIV₁, 128).

In this way, overhead for DCI transmission is reduced.

### Example Implementation of Device

FIG. 15 is a simplified block diagram of a device 1500 that is suitable for implementing embodiments of the present disclosure. The device 1500 can be considered as a further example implementation of the terminal device 110 or the network device 120 as shown in FIG. 1. Accordingly, the device 1500 can be implemented at or as at least a part of the terminal device 110 or the network device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1510 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, SI/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1530 is assumed to include program instructions that, when executed by the associated processor 1510, enable the device 1500 to operate in accordance with the embodiments of the present disclosure, as discussed herein with reference to FIGS. 3 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory; as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In some embodiments, a terminal device comprises circuitry configured to: receive, from a network device, a plurality of first data transmissions scheduled by first DCI and a second data transmission scheduled by second DCI; and transmit, to the network device, a first HARQ feedback for the plurality of first data transmissions and a second HARQ feedback for the second data transmission, the first HARQ feedback comprising a NACK for a first data transmission in the plurality of first data transmissions that is collided with a configured uplink symbol.

In some embodiments, the circuitry may be configured to transmit the first HARQ feedback by transmitting a first codebook for the first HARQ feedback, the first codebook comprising the negative acknowledgement in a HARQ-ACK bit position corresponding to a scheduled position for the collided first data transmission.

In some embodiments, the circuitry may be configured to transmit the first HARQ feedback by transmitting a first codebook for the first HARQ feedback, the first codebook comprising the negative acknowledgement behind HARQ-ACK bits for data transmissions in the plurality of first data transmissions other than the collided first data transmission.

In some embodiments, the circuitry may be further configured to: in accordance with a determination that only one of the plurality of first data transmissions is not collided with a configured uplink symbol, generate a codebook for the first and second HARQ feedbacks, the first HARQ feedback being only for the one of the plurality of first data transmissions; and transmit the codebook to the network device.

In some embodiments, the circuitry may be further configured to: in accordance with a determination that only one of the plurality of first data transmissions is not collided with a configured uplink symbol, generate a first codebook for the first HARQ feedback and a second codebook for the second HARQ feedback, the first HARQ feedback comprising a NACK or ACK for the one of the plurality of first data transmissions and NACKs for other data transmissions in the plurality of first data transmissions; and transmit the codebook to the network device.

In some embodiments, the circuitry may be configured to transmit the first and second HARQ feedbacks by generating the first HARQ feedback by grouping the plurality of first data transmissions into a plurality of groups: generating the second HARQ feedback by padding HARQ-ACK bits with a NACK so that the number of HARQ-ACK bits for the second HARQ feedback is equal to that for the first HARQ feedback: generating a codebook for the first and second feedbacks; and transmitting the codebook to the network device.

In some embodiments, the circuitry may be configured to transmit the first and second HARQ feedbacks by: generating the first HARQ feedback by grouping the plurality of first data transmissions into a plurality of groups: generating the second HARQ feedback, wherein the maximum number of transport blocks supported by serving cells of the terminal device is equal to the number of the plurality of groups: generating a codebook for the first and second feedbacks; and transmitting the codebook to the network device.

In some embodiments, a terminal device comprises circuitry configured to: receive, from a network device, a plurality of data transmissions scheduled by DCI: group the plurality of data transmissions based on the number of groups configured for the terminal device; and transmit, to the network device, a HARQ feedback generated for the grouped data transmissions.

In some embodiments, the number of groups may be commonly configured for serving cells of the terminal device. In some embodiments, the number of groups may be differently configured for each of serving cells of the terminal device. In these embodiments, the circuitry may be configured to group the plurality of data transmissions by: determining the maximum number among the numbers of groups configured for serving cells establishing a connection with the terminal device; and grouping the plurality of data transmissions based on the maximum number.

In some embodiments, the circuitry may be configured to group the plurality of data transmissions by: receiving, from the network device, a first indication for enabling the grouping; and grouping the plurality of data transmissions in response to the first indication.

In some embodiments, the circuitry may be further configured to receive, from the network device, a second indication for disabling the grouping; and transmit, to the network device, a further HARQ feedback generated for the plurality of data transmissions.

In some embodiments, a terminal device comprises circuitry configured to: receive, from a network device, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot; and determine the time domain resource for the corresponding data transmission based on each of the multiple parameters.

In some embodiments, the circuitry may be configured to determine the time domain resource by: determining the slot gap between the first and second slots by [SLIV₁/128], where SLIV₁ denotes the single value of each of the multiple parameters; and determining the information regarding the starting position and the length of the time domain resource on the first slot by mod (SLIV₁, 128).

In some embodiments, a network device comprises circuitry configured to: transmit, to a terminal device, a plurality of first data transmissions scheduled by first DCI and a second data transmission scheduled by second DCI; and receive, from the terminal device, a first HARQ feedback for the plurality of first data transmissions and a second HARQ feedback for the second data transmission, the first HARQ feedback comprising a NACK for a first data transmission in the plurality of first data transmissions that is collided with a configured uplink symbol.

In some embodiments, the circuitry may be configured to receive the first HARQ feedback by receiving a first codebook for the first HARQ feedback, the first codebook comprising the negative acknowledgement in a HARQ-ACK bit position corresponding to a scheduled position for the collided first data transmission.

In some embodiments, the circuitry may be configured to receive the first HARQ feedback by receiving a first codebook for the first HARQ feedback, the first codebook comprising the negative acknowledgement behind HARQ-ACK bits for data transmissions in the plurality of first data transmissions other than the collided first data transmission.

In some embodiments, the circuitry may be further configured to receive a codebook for the first and second HARQ feedbacks, the first HARQ feedback being only for one of the plurality of first data transmissions, only the one of the plurality of first data transmissions being not collided with a configured uplink symbol.

In some embodiments, the circuitry may be further configured to receive a first codebook for the first HARQ feedback and a second codebook for the second HARQ feedback, the first HARQ feedback comprising a NACK or ACK for one of the plurality of first data transmissions and NACKs for other data transmissions in the plurality of first data transmissions, only the one of the plurality of first data transmissions is not collided with a configured uplink symbol.

In some embodiments, the circuitry may be configured to receive the first and second HARQ feedbacks by receiving a codebook for the first and second feedbacks, the first feedback being generated by grouping the plurality of first data transmissions into a plurality of groups, the second HARQ feedback being generated by padding HARQ-ACK bits for the second HARQ feedback with a NACK so that the number of HARQ-ACK bits for the second HARQ feedback is equal to that for the first HARQ feedback.

In some embodiments, the circuitry may be configured to receive the first and second HARQ feedbacks by receiving a codebook for the first and second feedbacks, the first HARQ feedback being generated by grouping the plurality of first data transmissions into a plurality of groups, the maximum number of transport blocks supported by serving cells of the terminal device being equal to the number of the plurality of groups.

In some embodiments, a network device comprises circuitry configured to: transmit, to a terminal device, a plurality of data transmissions scheduled by DCI; and receive, from the terminal device, a HARQ feedback for the plurality of data transmissions grouped based on the number of groups configured for the terminal device. In some embodiments, the number of groups may be commonly configured for serving cells of the terminal device.

In some embodiments, the number of groups may be differently configured for each of serving cells of the terminal device. In these embodiments, the plurality of data transmissions is grouped based on the maximum number among the numbers of groups configured for serving cells establishing a connection with the terminal device.

In some embodiments, the circuitry may be further configured to transmit, to the terminal device, a first indication for enabling the grouping.

In some embodiments, the circuitry may be further configured to transmit, to the terminal device, a second indication for disabling the grouping; and receive, from the terminal device, a further HARQ feedback generated for the plurality of data transmissions.

In some embodiments, a network device comprises circuitry configured to: transmit, from a terminal device, DCI scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot.

In some embodiments, the slot gap between the first and second slots may be determined by [SLIV₁/128], where SLIV₁ denotes the single value of each of the multiple parameters; and the information regarding the starting position and the length of the time domain resource on the first slot may be determined by mod (SLIV₁, 128).

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk a random access memory (RAM), a read-only memory (ROM), an erasable programmable read-only memory (EPROM or Flash memory, an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

The invention claimed is:

1. A method of communication, comprising:
receiving, at a terminal device and from a network device, a plurality of first data transmissions scheduled by first downlink control information (DCI) and a second data transmission scheduled by second DCI; and
transmitting, to the network device, a first hybrid automatic repeat request (HARQ) feedback for the plurality of first data transmissions and a second HARQ feedback for the second data transmission, the first HARQ feedback comprising a negative acknowledgement (NACK) for a first data transmission in the plurality of first data transmissions that is collided with a configured uplink symbol.

2. The method of claim 1, wherein transmitting the first HARQ feedback comprises:
transmitting a first codebook for the first HARQ feedback, the first codebook comprising the negative acknowledgement in a HARQ-acknowledgement (HARQ-ACK) bit position corresponding to a scheduled position for the collided first data transmission.

3. The method of claim 1, wherein transmitting the first HARQ feedback comprises:
transmitting a first codebook for the first HARQ feedback, the first codebook comprising the negative acknowledgement behind HARQ-acknowledgement (HARQ-ACK) bits for data transmissions in the plurality of first data transmissions other than the collided first data transmission.

4. The method of claim 1, further comprising:
in accordance with a determination that only one of the plurality of first data transmissions is not collided with a configured uplink symbol, generating a codebook for the first and second HARQ feedbacks, the first HARQ feedback being only for the one of the plurality of first data transmissions; and
transmitting the codebook to the network device.

5. The method of claim 1, further comprising:
in accordance with a determination that only one of the plurality of first data transmissions is not collided with a configured uplink symbol, generating a first codebook for the first HARQ feedback and a second codebook for the second HARQ feedback, the first HARQ feedback comprising a NACK or acknowledgement (ACK) for the one of the plurality of first data transmissions and NACKs for other data transmissions in the plurality of first data transmissions; and
transmitting the codebook to the network device.

6. The method of claim 1, wherein transmitting the first and second HARQ feedbacks comprises:
generating the first HARQ feedback by grouping the plurality of first data transmissions into a plurality of groups;
generating the second HARQ feedback by padding HARQ-acknowledgement (HARQ-ACK) bits with a NACK so that the number of HARQ-ACK bits for the second HARQ feedback is equal to the number of HARQ-ACK bits for the first HARQ feedback;
generating a codebook for the first and second feedbacks; and
transmitting the codebook to the network device.

7. The method of claim 1, wherein transmitting the first and second HARQ feedbacks comprises:
generating the first HARQ feedback by grouping the plurality of first data transmissions into a plurality of groups;
generating the second HARQ feedback, wherein the maximum number of transport blocks supported by serving cells of the terminal device is equal to the number of the plurality of groups;
generating a codebook for the first and second feedbacks; and
transmitting the codebook to the network device.

8. A method of communication, comprising:
receiving, at a terminal device and from a network device, a plurality of data transmissions scheduled by downlink control information (DCI);
grouping the plurality of data transmissions based on the number of groups configured for the terminal device; and
transmitting, to the network device, a hybrid automatic repeat request (HARQ) feedback generated for the grouped data transmissions.

9. The method of claim 8, wherein the number of groups is commonly configured for serving cells of the terminal device.

10. The method of claim 8, wherein the number of groups is differently configured for each of serving cells of the terminal device, and wherein grouping the plurality of data transmissions comprises:
determining the maximum number among the numbers of groups configured for serving cells establishing a connection with the terminal device; and
grouping the plurality of data transmissions based on the maximum number.

11. The method of claim 8, wherein grouping the plurality of data transmissions comprises:
receiving, from the network device, a first indication for enabling the grouping; and
grouping the plurality of data transmissions in response to the first indication.

12. The method of claim 11, further comprising:
receiving, from the network device, a second indication for disabling the grouping; and
transmitting, to the network device, a further HARQ feedback generated for the plurality of data transmissions.

13. A method of communication, comprising:
receiving, at a terminal device and from a network device, downlink control information (DCI) scheduling multiple data transmissions, the DCI indicating multiple parameters for the multiple data transmissions, each of the multiple parameters having a single value that indicates a slot gap between a first slot of a corresponding data transmission and a second slot of a previous data transmission and that further indicates information regarding a starting position and a length of a time domain resource for the corresponding data transmission on the first slot; and
determining the time domain resource for the corresponding data transmission based on each of the multiple parameters.

14. The method of claim 13, wherein determining the time domain resource comprises:
determining the slot gap between the first and second slots by [SLIV₁/128], where SLIV₁ denotes the single value of each of the multiple parameters; and
determining the information regarding the starting position and the length of the time domain resource on the first slot by mod (SLIV₁, 128).

15.-30. (canceled)
